(19) United States
(12) Patent Application Publication
(10) Pub. No.: US 2005/0277397 A1
(43) Pub. Date: Dec. 15, 2005

(54) Frequency generator

(76) Inventors: Niels Christoffers, Duisburg (DE); Bedrich Hosticka, Duisburg (DE); Rainer Kokozinski, Oberhausen (DE); Peter Jung, Otterberg (DE)

Correspondence Address: GARDNER GROFF, P.C., 2018 POWERS FERRY ROAD, SUITE 800, ATLANTA, GA, 30339, US

(21) Appl. No.: 11/140,259

(22) Filed: May 27, 2005

Related U.S. Application Data
(63) Continuation of application No. PCT/EP02/13455, filed on Nov. 28, 2002.

(51) Int. Cl. H04B 1/40; H04B 1/06; H04B 7/00

(52) U.S. Cl. 455/255; 455/76

(57) ABSTRACT

A frequency generator according to the invention includes a controllable oscillator comprising a control input and an oscillator output, wherein the controllable oscillator is formed to output, at the oscillator output, an oscillator signal with an oscillator frequency dependent on a control signal at the control input, sampling means for sampling the oscillator signal or a signal of the controllable oscillator derived therefrom with a reference frequency, in order to obtain a sample signal, and a low-pass filter for low-pass filtering the sample signal or a signal derived therefrom, in order to obtain the control signal or a signal underlying the control signal. Due to the less intensive construction, in particular the lack of a frequency divider, and the quicker adjustability of the currently generated frequency, according to the invention, more current-saving frequency generation may be obtained.

### CROSS-REFERENCE TO RELATED APPLICATION

This application is a continuation of and claims priority to co-pending International Application No. PCT/EP02/13455, filed Nov. 28, 2002, which designated the United States and was not published in English and is incorporated herein by reference in its entirety.

### BACKGROUND OF THE INVENTION

1. Field of the Invention

The present invention relates to frequency generators, as they are for example employed in transceivers for UMTS, GSM, or Bluetooth.

2. Description of the Related Art

A central task within transceivers employed for wireless data transmission consists in the generation of local, periodic signals used for frequency conversion of signals received or to be sent. Here, the local periodic signal generated has to comprise different frequencies in different operational states depending on transmission standard, such as depending on whether a sending or receiving operation is present. The function of the generation of the local periodic signal is taken over by a controllable oscillator, which most frequently is a voltage-controlled oscillator (VCO).

Since according to today's prior art high-resolution analog/digital and digital/analog converters are available as embedded integrated circuits, for frequency generation the circuitry shown in FIG. 6 would be desirable, which consists of a ROM memory 900, a digital/analog converter 902 and a voltage-controlled oscillator 904. Depending on the desired transmission channel to be used in data reception or in sending for frequency conversion, a digitized control value is taken from the ROM 900. This is converted to an analog value by the digital/analog converter 902 and input into a control input of the VCO 904. The latter would then output the local periodic signal with the desired frequency, wherein the digital control values stored in the EEPROM 900 have been suitably adjusted. The circuitry of FIG. 6 would be particularly desirable because the output frequency would change almost immediately after a new channel has been selected, so that only a short settling time would have to be waited for before data could be sent or received by the transceiver contained in the circuitry of FIG. 6.

Circuitry according to FIG. 6, however, is not employable due to the high demands on the accuracy with which the frequency of the signal generated by the VCO 904 has to match the frequency required by the channel selection. For the output frequencies to match the frequencies required by the channel selection with the desired accuracy, the control voltage-frequency characteristic curve of the VCO 904 has to be known exactly enough. In general, however, this depends on fabrication fluctuations, temperature, and age and would thus have to be determined at regular, shortly successive time instants. Up to now, however, a single accurate determination of the characteristic curve immediately after the fabrication was already seen as uneconomical, because highly accurate measuring devices are required for this. Circuitry according to FIG. 6 is therefore not employable in current transceivers due to the high demands on accuracy.

Potential frequency generators, as they may be employed in transceivers, are constructed as illustrated in FIG. 1 and include a phase and frequency detector 910, a loop filter 912, a VCO 914, and a frequency divider 916. A highly accurate reference signal S_{ref}(t) generated by a quartz (not shown) is applied to a first input of the phase and frequency detector 910. From the output signal S_{d}(t) of the latter, the loop filter 912 then generates a control signal S_{LOC}(t) and outputs it to the VCO 914. The VCO 914 generates an output signal Sₒᵤₜ(t) with a frequency depending on the control signal S_{LOC}(t), which represents the output signal of the frequency generator. The output signal Sₒᵤₜ(t) of the VCO 914 is fed back into a second input of the PFD 910 via the frequency divider 916. The frequency divider 916 generates a signal with an N times lower frequency from the signal Sₒᵤₜ(t). The PFD 916 compares the frequency-divided signal from the frequency divider 916 with the highly accurate reference signal S_{ref}(t) and outputs, as the signal S_{d}, a signal corresponding to the phase and frequency difference, whereby a locked loop is formed through the PFD 910, the loop filter 912, the VCO 914, and the frequency divider 916 with a feedback loop of the frequency divider 916, the PFD 910, and the loop filter 912. The frequency generator of FIG. 7 thus enables that the output frequency Sₒᵤₜ(t) is N times the reference frequency with high accuracy, wherein N is the division ratio of the frequency divider 916, by providing the frequency divider 916 as variation to a phase locked loop (PLL).

It is disadvantageous in the frequency divider of FIG. 7 that the frequency divider 916 is difficult and expensive to realize. Because it has to be dimensioned for a very high input signal bandwidth, it consumes very much current. A further disadvantage of the frequency generator of FIG. 7 consists in its high inertia. After a change of the frequency ratio N at the frequency divider 916, a long settling duration passes until the output frequency Sₒᵤₜ matches the desired one with sufficient accuracy.

### SUMMARY OF THE INVENTION

It is therefore an object of the present invention to provide a scheme for frequency generation enabling less intensive, more accurate, and/or less inert frequency generation.

In accordance with a first aspect, the present invention provides a frequency generator, having: a controllable oscillator having a control input and an oscillator output, wherein the controllable oscillator is formed to output, at the oscillator output, an oscillator signal with an oscillator frequency dependent on a control signal at the control input; a sampler for sampling the oscillator signal or a signal of the controllable oscillator derived therefrom with a reference frequency in order to obtain a sample signal; and a low-pass filter for low-pass filtering the sample signal or a signal derived therefrom in order to obtain the control signal or a signal underlying the control signal.

In accordance with a second aspect, the present invention provides a method of frequency generation by means of a controllable oscillator having a control input and an oscillator output, wherein the controllable oscillator is formed to output, at the oscillator output, an oscillator signal with an oscillator frequency dependent on a control signal at the control input, the method having the steps of: sampling the oscillator signal or a signal of the controllable oscillator derived therefrom with a reference frequency in order to obtain a sample signal; and low-pass filtering the sample signal or a signal derived therefrom, in order to obtain the control signal or a signal underlying the control signal.

In accordance with a third aspect, the present invention provides an apparatus for determining the control signal-oscillator frequency characteristic curve of a controllable oscillator having a control input and an oscillator output, wherein the controllable oscillator is formed to output, at the oscillator output, an oscillator signal with an oscillator frequency dependent on a control signal from the control input, the apparatus having: a sampler for sampling the oscillator signal or a signal of the controllable oscillator derived therefrom with a reference frequency in order to obtain a sample signal; a low-pass filter for low-pass filtering the sample signal or a signal derived therefrom, in order to obtain a signal underlying the same; a switch for selectively preventing or enabling the oscillator signal to reach the control input, passing through the sampler and the low-pass filter; an adder formed to add a predetermined constant control value to the signal underlying the control signal, in order to obtain the control signal; a detector for detecting the value of the control signal; and a controller for determining the predetermined constant control value, which is formed to cause the switch for selectively preventing or enabling to prevent the oscillator signal from reaching the control input, passing through the sampler and the low-pass filter; the adder to then use an experimental value for addition; the switch for preventing or enabling to then enable the oscillator signal to reach the control input, passing through the sampler and the low-pass filter; the detector to then detect the value of the control signal adjusting itself upon enabling, in order to obtain a control value associated with a predetermined multiple of the reference frequency via the control signal-oscillator frequency characteristic curve; and these processes to be repeated for various experimental values.

In accordance with a fourth aspect, the present invention provides a method of determining the control signal-oscillator frequency characteristic curve of a controllable oscillator having a control input and an oscillator output, wherein the controllable oscillator is formed to output, at the oscillator output, an oscillator signal with an oscillator frequency dependent on a control signal from the control input, the method having the steps of: sampling the oscillator signal of the controllable oscillator or a signal derived therefrom with a reference frequency, in order to obtain a sample signal; low-pass filtering the sample signal or a signal derived therefrom, in order to obtain a signal underlying the same; preventing the oscillator signal from reaching the control input, passing through the sampler and the low-pass filter; adding an experimental value to the signal underlying the control signal, in order to obtain the control signal; enabling the oscillator signal to reach the control input, passing through the sampler and the low-pass filter; detecting the value of the control signal adjusting itself upon enabling, in order to obtain a control value associated with an integer multiple of the reference frequency via the control signal-oscillator frequency characteristic curve; and repeating the steps for various experimental values.

A frequency generator according to the invention includes a controllable oscillator having a control input and an oscillator output, wherein the controllable oscillator is adapted to output, at the oscillator output, an oscillator signal with an oscillator frequency dependent on a control signal at the control input, sampling means for sampling the oscillator signal or a signal of the controllable oscillator derived therefrom with a reference frequency, in order to obtain a sample signal, and a low-pass filter for low-pass filtering the sample signal or a signal derived therefrom in order to obtain the control signal or a signal underlying the control signal.

An inventive method of frequency generation by means of a controllable oscillator comprising a control input and an oscillator output, wherein the controllable oscillator is adapted to output, at the oscillator output, an oscillator signal with an oscillator frequency dependent on a control signal at the control input, includes sampling the oscillator signal or a signal of the controllable oscillator derived therefrom with a reference frequency in order to obtain a sample signal, and low-pass filtering the sample signal or a signal derived therefrom in order to obtain the control signal or a signal underlying the control signal.

According to a further aspect of the present invention, a determination of the control signal-oscillator frequency characteristic curve of a controllable oscillator comprising a control input and an oscillator output is provided, wherein the controllable oscillator is adapted to output, at the oscillator output, an oscillator signal with oscillator frequency dependent on a control signal from the control input. A sampling means samples the oscillator signal or a signal of the controllable oscillator derived therefrom with a reference frequency in order to obtain a sample signal. A low-pass filter low-pass filters the sample signal or a signal derived therefrom to obtain a signal underlying it. Means is provided to selectively prevent or enable that the oscillator signal reaches the control input, passing through the sampling means and the low-pass filter. An adder adapted to add a predetermined constant control value to the signal underlying the control signal in order to obtain the control signal is also provided. A detector detects the value of the control signal. Control means for determining the predetermined constant control value is adapted to cause the means for selectively preventing or enabling to prevent the oscillator signal from reaching the control input, passing through the sampling means and the low-pass filter and then the adder from using an experimental value for addition. Moreover, the control means then causes the means for preventing or enabling to enable the oscillator signal to reach the control input, passing through the sampling means and the low-pass filter and then the detector to detect the value of the control signal adjusting toward enabling, in order to obtain a control value associated with a predetermined multiple of the reference frequency via the control signal-oscillator frequency characteristic curve. The control means further causes these processes to be repeated for various experimental values.

The present invention thus provides a completely new principle for frequency generation, which basically differs from the PLL-based principle described in the introductory section of the description. Frequency dividers and phase detectors are done without. The adjustability of the settled frequency is possible quickly, because by interrupting a feedback path between oscillator output and control input including the sampling means and the low-pass filter, roughly adjusting the control signal to a stored control value, and renewed closing of the feedback path the settling process may be started with a roughly preset value. Long settling processes of a frequency divider are avoided. Due to the less intensive construction, in particular the lack of a frequency divider, and the quicker adjustability of the currently generated frequency, according to the invention, more current-saving frequency generation may be obtained.

### BRIEF DESCRIPTION OF THE DRAWINGS

These and other objects and features of the present invention will become clear from the following description taken in conjunction with the accompanying drawings, in which:

FIG. 1 is a schematic block circuit diagram of a frequency generator according to a simplified embodiment of the present invention;

FIG. 2 is a spectral distribution of the sample signal acquired from the oscillator signal of the controllable oscillator of the frequency generator of FIG. 1;

FIGS. 3a and 3b are example waveforms of the oscillator signal, the sample signal and the control signal in the frequency generator of FIG. 1 for two different settled or stationary states, namely for a division ratio between reference frequency and oscillator frequency of two in the case of FIG. 3a and of one in the case of FIG. 3b;

FIG. 4 is a schematic block circuit diagram of a frequency generator according to a further embodiment;

FIG. 5 is an exemplary control signal-oscillator frequency characteristic curve of a controllable oscillator;

FIG. 6 is a desired, ideal circuitry for a frequency generator for generating signals with different frequencies; and

FIG. 7 is a block circuit diagram of a conventional PLL-based frequency generator.

### DESCRIPTION OF THE PREFERRED EMBODIMENTS

Before various embodiments of the present invention will be explained in more detail on the basis of the drawings in the following, it is pointed out that like elements or ones with like functions are provided with the same or similar reference numerals or designations in the figures, and that repeated explanation of these elements is omitted.

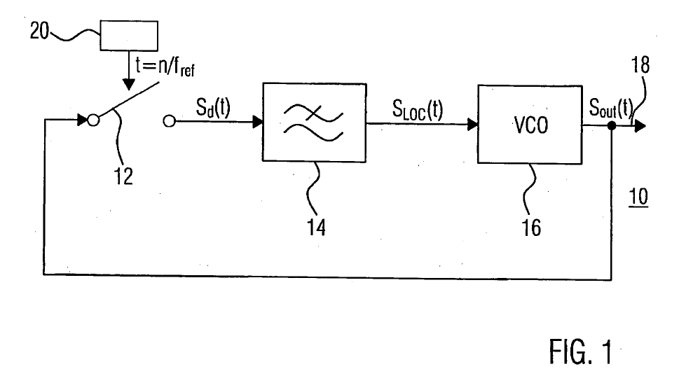

FIG. 1 shows a simplified embodiment of a frequency generator according to the present invention, wherein the frequency generator is generally indicated at 10 in FIG. 1. The frequency generator 10 includes a sampler 12, a low-pass filter 14, and a voltage-controlled oscillator (VCO) 16. The voltage-controlled oscillator 16 includes a control input and an oscillator output and outputs, at its oscillator output, an output signal Sₒᵤₜ(t) with an oscillator frequency fₒᵤₜ or an angular frequency ωₒᵤₜ, which in turn depends on the control signal the VCO 16 receives at the control input. The output of the VCO 16 at the same time corresponds to the output 18 of the frequency generator 10. Accordingly, also the output signal Sₒᵤₜ of the VCO 16 is the signal output by the frequency generator 10.

The oscillator output of the VCO 16 is also connected to an input of the sampler 12. The sampler 12 samples the output signal Sₒᵤₜ from the VCO 16 with a frequency f_{ref} and outputs, at its output connected to an input of the low-pass filter 14, a sample signal S_{d}(t). The sample signal S_{d}(t) comprises t=n/f_{ref} (nε|N) individual pulses at the time instants of sampling, the strength of which corresponds to the value of the output signal Sₒᵤₜ at the time of the respective sampling, and the pulse duration of which is set to a fixed value. For sampling, the sampler 12 receives a highly accurate reference signal with the reference frequency f_{ref} from an oscillator 20 such as a quartz oscillator at a frequency input. The sampler 12 for example includes a switch, such as a FET.

The low-pass filter 14 is connected to the control input of the VCO 16 at its output and outputs the sample signal S_{d} in low-pass-filtered form as the control signal S_{LOC}(t) thereto. Sampler 12, low-pass filter 14, and VCO 16 together form a locked loop, which, as will be explained in the following, controls the output signal Sₒᵤₜ(t) to a frequency that is in an integer ratio to the reference frequency. In other words, the feedback path including the sampler 12 and the low-pass filter 14 between the oscillator output and the control input of the VCO 16 causes the control signal received from the VCO to be controlled to such a value corresponding to an oscillator frequency that is in an integer ratio to the reference frequency, according to the control signal-oscillator frequency characteristic curve of the VCO 16.

Since the construction of the frequency generator 10 as well as the functioning of its individual components has been briefly described above, its overall functioning by the interplay of all components will be described in the following. As already mentioned, the VCO 16 always generates a substantially mono-frequent signal at a frequency depending on the height of the control signal S_{LOC} at its output. The high-frequency output signal Sₒᵤₜ of the VCO 16 may thus be illustrated as two Dirac bursts at the frequencies or angular frequencies +/− ωₒᵤₜ in the frequency domain (in the following ω is to represent the angular frequency connected to the frequency f by f=2π/ω, wherein in the following ω and f will be designated as frequency for reasons of simplicity).

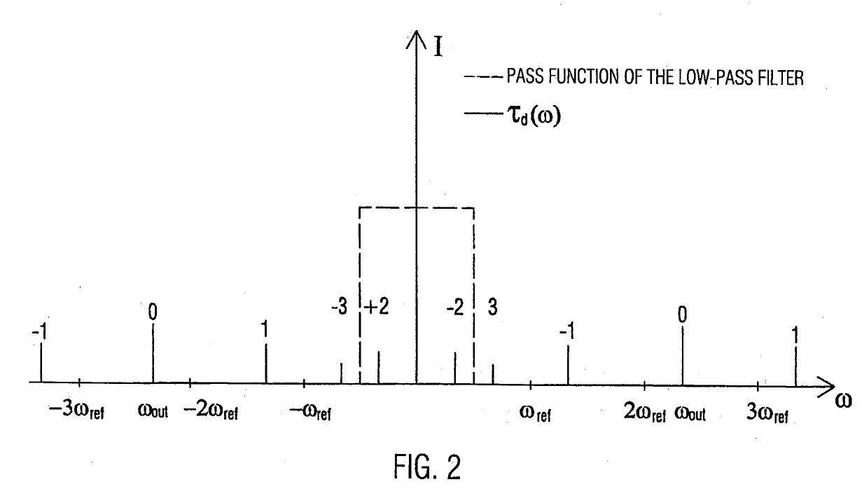

The sampling of the output signal Sₒᵤₜ of the VCO 16 by the sampler 12 at the frequency f_{ref} at time instants tₙ=n/f_{ref} corresponds to a multiplication of the signal Sₒᵤₜ(t) by a comb signal comb_{f}_{^{−1}}_{_{ref}}(t) with Dirac bursts at the sample time instants in the time domain, so that S_{d}(t)=comb_{f}_{^{−1}}_{_{ref}}(t)·Sₒᵤₜ(t) applies. In the frequency domain this corresponds to a convolution of the Fourier transform of the output signal \tilde{S}ₒᵤₜ(ω) with the Fourier transform of the sample comb function, which itself is in turn a comb function with Dirac bursts at the frequencies n·ω_{ref} (nε|N), namely comb_{f}_{^{−1}}_{_{ref}}(t), so that \tilde{S}_{d}(ω)=\tilde{S}ₒᵤₜ(ω)*comb_{f}_{^{−1}}_{_{ref}}(t) applies for the Fourier transform of the sample signal. The function \tilde{S}_{d}(ω) is illustrated in FIG. 2 in which the frequency ω is plotted along the x axis and the intensity along the y axis in arbitrary units each. As can be seen, the sample signal S_{d} includes a series of Dirac bursts at the frequencies +/−ωₒᵤₜ+n·ω_{ref} in the frequency domain, wherein n is a natural number and ω_{ref} the angular frequency of the reference signal from the oscillator 20. The numbers above each Dirac burst in FIG. 2 each indicate the value of n corresponding to the respective Dirac burst.

The sample signal S_{d}, the spectral illustration \tilde{S}_{d} of which is illustrated in FIG. 2, is low-pass-filtered at the low-pass filter 14. The cutoff frequency of the low-pass filter 14 is adjusted such that among the Dirac bursts of the sample signal \tilde{S}_{d} only the two with the lowest frequencies of the frequency +−(ωₒᵤₜ−N·ω_{ref}) (presently N=2) are filtered out in order to obtain the signal S_{LOC}(t). For this, the low-pass filter 14 for example comprises a rectangular pass function, as it is exemplarily shown in FIG. 2 with a dashed line. The cutoff frequency of the low-pass filter 14 is preferably ω_{ref}/2. \tilde{S}_{LOC}(ω) thus corresponds to \tilde{S}_{d}(ω)·rect_{1/2ω}_{_{ref}}(ω), wherein rect_{1/2ω}_{_{ref}}(ω) is a function that is one between −ω_{ref}/2 and ω_{ref}/2 and zero otherwise. The arising signal S_{LOC}(t) is input into the VCO 16 for control or used for the control thereof.

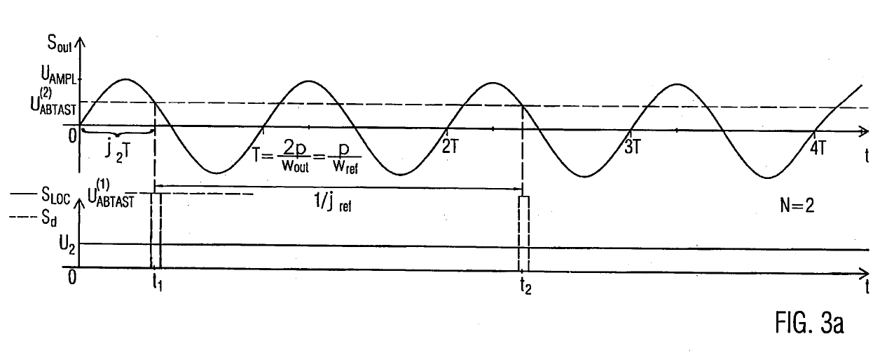

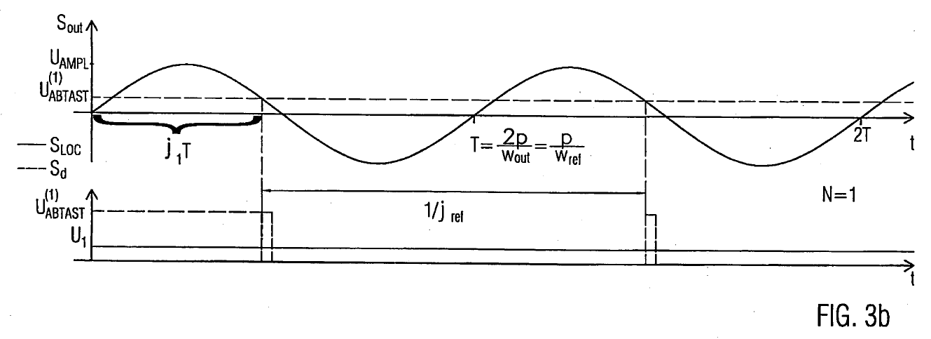

By theoretical considerations it can be shown that the frequency generator 10 controls the control signal SLOC(t) such that a static state arises, in which the output frequency ωₒᵤₜ of the output signal Sₒᵤₜ(t) is Nω_{ref}, wherein N is an integer. In order to illustrate the regulation principle, in FIGS. 3a and 3b, two stable or static states of the frequency generator 10 of FIG. 1 are exemplarily illustrated, namely in FIG. 3a for the case N=2 and in FIG. 3b for the case N=1. Both figures show only exemplarily the time courses of the signal Sₒᵤₜ, S_{LOC}, and S_{d} in two graphs aligned with each other and arranged above each other, in which the time t is plotted along the x axis and the voltage along the y axis in arbitrary units. In the upper graph, the temporal courses of the output signal Sₒᵤₜ (solid line) are illustrated each, and in the lower graphs the temporal courses of the sample signal S_{d} (solid line) and the control signal S_{LOC} (dashed line).

As can be seen, in the static state, the samples by the sampler 12 always take place with a constant phase difference φ1 or φ2 to the output signal Sₒᵤₜ to be sampled. In other words, the sample by the sampler 12 always takes place at corresponding locations of the, in the present case, falling edge of the sinusoidal output signal Sₒᵤₜ of the oscillator 16, namely at every Nth period, wherein the period duration T is T2π/ωₒᵤₜ. This circumstance can be explained when paying attention to the fact that, in the static state, since the output signal Sₒᵤₜ has a constant frequency of Nωref, the control signal S_{LOC} has to be constant and has to have a value corresponding to the frequency ωₒᵤₜ according to the control signal-oscillator frequency characteristic curve of the VOC 16. As can be recognized in FIGS. 3a and FIG. 3b, presently the control signal S_{LOC} constantly has to have the value U₂ for the state ωₒᵤₜ=2 ω_{ref}, while the same has to be constantly U1 in the static state with N=1.

Due to the fact that the sample by the sampler 12 takes place with a fixed frequency f_{ref} and the pulses the sampler 12 generates are always in a predetermined ratio to the value of the output signal Sₒᵤₜ to be sampled at the sample time instant regarding the height or strength and are almost constantly adjusted to a value regarding the pulse duration, and the sample signal is otherwise zero, in the static state the sample pulses of the sample signal S_{d} have to have a certain voltage height Uₛₐₘₚₗₑ. This voltage height Uₛₐₘₚₗₑ is determined from the fact that, in the static state, it has to lead to a control signal S_{d} (presently illustrated in an exaggeratedly constant manner) with a constant “effective value” by the low-pass filtering by the low-pass filter 14, which is U₁ or U₂. Due to this fact it may be explained that the sample time instants resulting in the static states are such points of the output signal Sₒᵤₜ at which the signal Sₒᵤₜ has the value Uₛₐₘₚₗₑ.

As can be recognized, the sample in the static case N=2 only takes place in every second period, while in the static case N=1 it takes place in every period. Moreover, the value that the output signal Sₒᵤₜ of the VCO 16 to be sampled has at the sample time instants, i.e. Uₛₐₘₚₗₑ, is greater in the case of N=2 than in the case N=1, because also the effective value U₂ resulting by the filtering has to be greater in the case of the higher output frequency ωₒᵤₜ at N=2 than in the case N=1, i.e. the case of the smaller output frequency.

On the basis of FIGS. 3a and 3b, it may now be explained how a small deviation of the output signal Sₒᵤₜ from the static state is corrected by the feedback. Imagine, for example, that in the case of FIG. 3a the output signal Sₒᵤₜ has become a bit faster between the sample time instants T₁ and T₂. In this case, the signal Sₒᵤₜ takes on the value Uₛₐₘₚₗₑ earlier than at the sample time instant t₂. At the time t₂ the value of Sₒᵤₜ is slightly lower. Correspondingly, also the value of the low-pass-filtered control signal S_{LOC} decreases to become slightly lower than U₂, whereby the VCO 16, which became too fast, is again “braked” due to the decreasing control signal. In the other case, since between the time instants t₁ and t₂ the VCO has become slower, the sampled value at the time t₂ is greater than Uₛₐₘₚₗₑ, so that also the effective value of the control signal S_{LOC} developing by the low-pass filtering increases, whereby the VCO 16, which has become slower, is “accelerated” with a higher control signal.

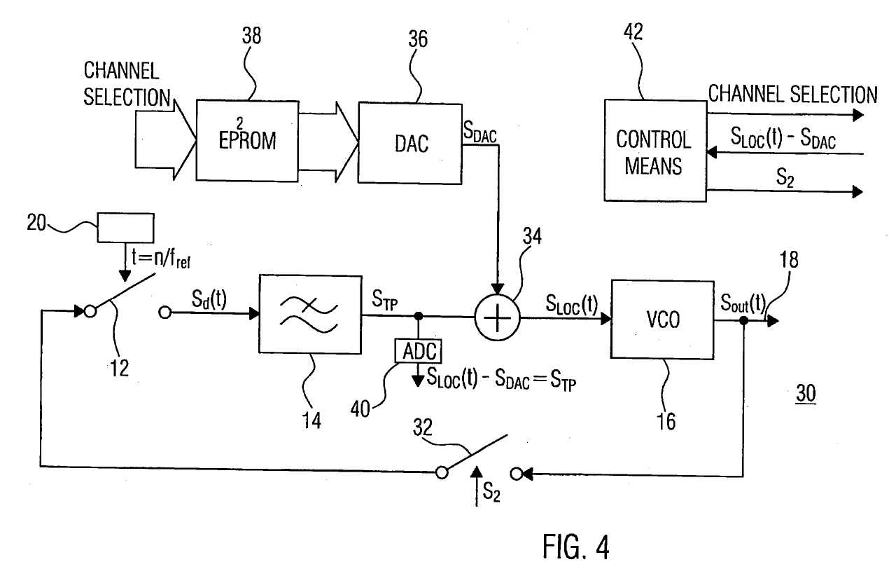

With reference to FIGS. 1, 2, 3a, and 3b it is pointed out that the previous description only refers to an exemplary embodiment and that various changes to the frequency generator 10 of FIG. 1 or its locked loop may be made. For example, an inverter could be connected into the feedback path. In the case of an inverter in the feedback path downstream of the sampler 12, sampling in the static state would for example always take place at the rising edges of the sinusoidal output signal Sₒᵤₜ. Furthermore, an offset could be imparted on the control signal S_{LOC} output from the low-pass filter 14, on the way to the control input of the VCO 16, as it will be the case in the embodiment of FIG. 4. In this case, the sample time instants in the static state only adjust to a different phase value or different sample time instants compared with the example of FIGS. 3a and 3b, at which the output signal Sₒᵤₜ has such a value that yields, by the filtering by the low-pass filter 14, an effective value only corresponding to the deviation of the offset from the target value U₁ or U₂ of the control signal for the VCO 16. Furthermore, an amplifier could be provided in the feedback path. The signal generated by the low-pass filter 14 thus represents a control signal for the VCO, which can, if necessary, still be subjected to constant manipulation, i.e. addition and multiplication, depending on the application case, before being input to the VCO. The oscillator signal sampled by the sampling means and the sample signal filtered by the low-pass filter may also have been manipulated, i.e. provided with an offset or an amplification, beforehand.

It should be pointed out that previously, for greater ease understanding, the problem has not been gone into as to which of the different stable or static states the frequency generator 10 of FIG. 1 adjusts, i.e. to which frequency ratio between reference and oscillator frequency. A simple possibility would be, as briefly mentioned as an alternative above, to bias the control input of the VCO with a constant offset so that in the startup of the frequency generator the output frequency Sₒᵤₜ always settles to the next frequency that is an exact integer multiple of the reference frequency. In this manner, a frequency generator may be obtained, which always generates an exactly defined frequency, namely a predetermined integer multiple of the reference frequency.

In the following, with reference to FIG. 4, an embodiment for a frequency generator according to the present invention is described, which is suitable for the generation of a selected one among predetermined oscillator frequencies, which all have an integer division ratio to the reference frequency.

The frequency generator of FIG. 4 is generally indicated at 30. In addition to the components of the frequency generator of FIG. 1, namely the sampler 12, the low-pass filter 14, the voltage-controlled oscillator 16, the output 18, and the reference signal generator 20, it includes a switch 32 for interrupting the feedback branch or the locked loop, which is connected into the feedback branch between the oscillator output of the VCO 16 and the input of the sampler 12, an adder 34, which has one input connected to the output of the low-pass filter 14 and its output to the control input of the VCO 16, a digital/analog converter 36, the output of which is connected to a further input of the adder 34, an EEPROM memory 38, the output of which is connected to the input of the D/A converter 36 for outputting read-out data, an analog/digital converter 40, the input of which is connected to the output of the low-pass filter 14, and a control means 42, which is connected to an input of the EEPROM memory 38 for channel selection and control signal-oscillator frequency characteristic curve calibration or measurement, to an output of the A/D converter 40 for the detection of a digitized value of the output signal of the low-pass filter 14, and to a control input of the switch 32.

After the construction of the frequency generator 30 of FIG. 4 has been described above, its functioning will be described in the following. For easier understanding, it is assumed that the frequency generator is integrated in a transceiver circuit using various frequencies per channel for transmission when sending and receiving. The control means 42 may also be part of the transceiver circuit (not shown).

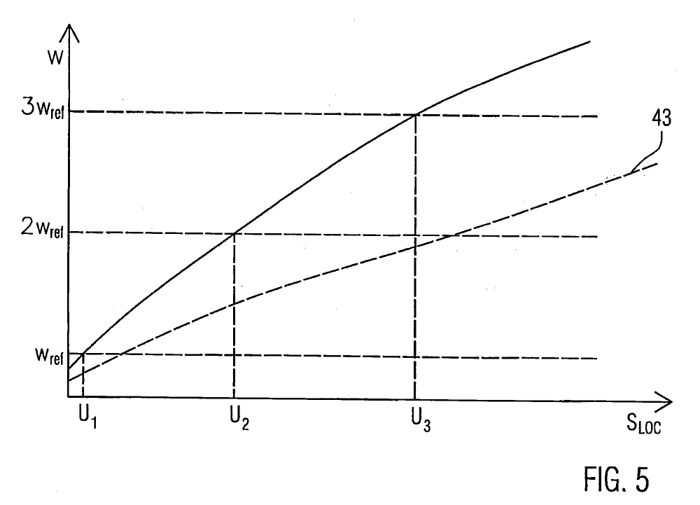

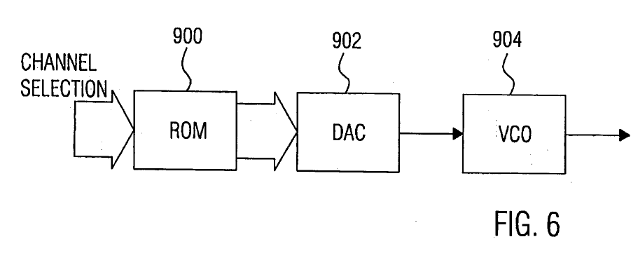

Each channel of the transceiver is associated with a different frequency that is an integer multiple of the reference frequency ω_{ref}, i.e. N·ω_{ref} (N.E.|N). In the EEPROM 38, a channel association table is stored that associates each channel with a digital value corresponding to about the target value of the control signal, which corresponds to about the frequency associated with the respective channel according to the control signal-oscillator frequency characteristic curve. In FIG. 5, in a graph in which the control signal is plotted along the x axis in arbitrary voltage units and the frequency ω along the y axis in arbitrary Hertz units, a control signal-oscillator frequency characteristic curve of the VCO 16 is exemplarily illustrated. The characteristic curve intersects, as illustrated, the ordinate frequency values ω_{ref}, 2 ω_{ref} and 3 ω_{ref} at the abscissa voltage values U₁, U₂, or U₃. In this exemplary case for example three digital values would be stored in the EEPROM 38, namely the digitized values of U₁, U₂, or U₃, namely in respective association with the channels having the frequencies ω_{ref}, 2 ω_{ref} and 3 ω_{ref}.

In the case of the control means 42 selecting a new channel, the control means 42 accesses the EEPROM 38 with the selected channel as index, whereupon the EEPROM 38 outputs the corresponding digital value to the D/A converter 36. Until the next change of channel, the digital value remains unchanged or constant. The D/A converter 36 converts the digital value to the analog voltage value S_{DAC} and outputs it to the second input of the adder 34. As already described previously with reference to the embodiment of FIGS. 1-3b, hereby a constant offset is generated in the feedback branch of the locked loop of the components 12, 14, and 16, which only leads to the fact that the locked loop adjusts to a stationary state, in which the samples by the sampler 12 take place at locations of the periodic signal Sₒᵤₜ of the VCO 16 at which the signal Sₒᵤₜ is lower, namely so low that the effective value generated by the filter 14 only corrects the rough bias of the control input of the VCO 16 by the control value S_{DAC}.

In operation, the control means 42 controls the course of the frequency generator 30 as follows: at first the switch 32 remains open in order to interrupt the feedback loop and the locked loop. The control means 42 selects a channel and accesses the EEPROM 38 with the selected channel as index. For example, the digital value associated with the selected channel corresponds to the value U₂. The D/A converter 36 therefrom generates the analog offset signal S_{DAC} and applies it to the second input of the adder 34. At the first input of the adder, there is not any signal yet, because the switch 32 has interrupted the feedback branch. At the control input of the VCO 16 therefore only the signal S_{DAC} is present. The VCO 16, at its output, therefore outputs an oscillator signal Sₒᵤₜ with a frequency ωₒᵤₜ matching the frequency 2 ω_{ref} with an accuracy that, as it has been described in the introductory section of the description, is not exact enough for a sending or receiving operation by variations of the temperature or the age. After this rough presetting, the control means 42 closes the switch 32 and thus also the feedback path or the locked loop. As described with reference to FIGS. 1-3b, the locked loop adjusts the oscillator frequency ωₒᵤₜ to the next frequency having an integer ratio to the reference frequency ω_{ref}. Presently, by the presetting of the control signal S_{LOC} of the VCO 16 before closing the switch 32, it is clear with sufficient certainty that the locked loop will adjust to the desired frequency, here 2 ω_{ref}, since this is the next frequency at the beginning of the control process after closing the switch 32. In other words, since the output frequency of the VCO 16 after presetting the control signal before closing the switch 32 is known in an “inaccurate” manner, the output frequency after settling after closing the switch 32 is also known.

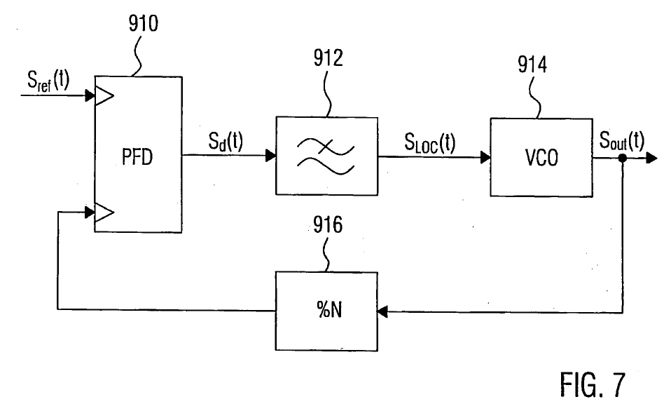

Upon change of channel, the process is repeated. The control means 42 at first opens the switch 32, selects a new channel, and closes the switch 32 again. By the presetting of the control signal S_{d}, the adjustment time duration to the new frequency is shorter than in a locked loop including a frequency divider, as it has been described with reference to FIG. 7.

As already described in the introductory section of the description of the present invention, the control signal-oscillator characteristic curve of the VCO 16 is subject to changes which could lead to the formerly digitized values, such as U₁-U₃, deviating from the target control values according to the control signal-oscillator frequency characteristic curve of the VCO 16. In the presetting of the control signal of the VCO 16 in the above-described manner, these stored digitized values deviating from the target values in their function as starting value for the control process could lead to the locked loop adjusting to an undesired neighboring frequency, which is another integer multiple of the reference frequency. In FIG. 5, for example, with a dashed line 43, a changed characteristic curve of the VCO 16 is exemplarily shown, as it has for example resulted after a temperature change. As can be recognized, when the control means 42 selects the channel associated with the frequency 2 ω_{ref} for the next time, the VCO 16 is preset with the value U₂ leading to a frequency lying exactly between the frequencies 2 ω_{ref} and ω_{ref} after opening the switch 32. After closing the switch 32 it is therefore not ensured that the locked loop adjusts to the desired frequency value 2 ω_{ref}, and not to the neighboring value ω_{ref}.

In order to avoid this, the frequency generator 30 of FIG. 4 includes another functionality, namely calibrating or determining the control signal-oscillator frequency characteristic curve of the VCO 16, which process will be described in the following and will be repeated again and again during the operation of the frequency generator 30 for example intermittently in fixed temporal intervals sufficient to be able to follow the temporal changes of the characteristic curve of the VCO.

In the case of the control means 42 ascertaining that a renewed calibration of the control signal-oscillator frequency characteristic curve of the oscillator 16 is necessary again, the control means 42 takes the following steps in order to obtain a new, corrected digitized value for each channel or for each frequency of a multiple of the reference frequency: the control means 42 opens the switch 32, selects a first channel in order to preset the VCO 16, closes the switch 32 again, waits for a certain adjustment time of the locked loop until a static state has resulted, and then reads out, by means of the A/D converter 40 as detection means, a digitized value of the signal S_{TP} representing the deviation of the difference between the true target value S_{LOC}(t) of the VCO 16 at the control input thereof and the analog control value of the DAC 36, S_{DAC}, which has resulted due to the above-mentioned characteristic curve fluctuations. Hereupon, the control means 42 corrects the value stored in the EEPROM 38 with the newly-detected value, namely S_{LOC}(t), by adding the detected value S_{TP} to the previously stored value of S_{DAC}. The control means 42 repeats these steps for each channel or each frequency N·ω_{ref}. In this manner, all stored values in the EEPROM 38 are again adapted to the possibly changed characteristic curve. Moreover, the process is not so time-consuming, because the old stored digitized values lead to quick adjustment times by their use as control starting values for the control value of the VCO.

In the case of the channel generator 30 not being in operation for a long time, or in the case of the frequency generator 30 being used for the first time, no suitable sufficiently accurate predetermined digitized values are present in the EEPROM for the characteristic curve determination, so that the control means 42 has to sample the characteristic curve of the VCO 16 by another algorithm than the one previously described. In this case, the control means 42, by sensitive variation of the value output by the DAC 36, has to find the one in which the difference between the control signal of the VCO 16 and the output voltage of the DAC 36 becomes zero, in order to digitize the same and store it into the association table in the EEPROM 38. By successively opening the switch 32, subsequent rough variation of the control voltage, renewed closing of the switch 32, and digitization of the control voltage S_{TP}, all points on the control voltage-frequency characteristic curve for which the output frequency is an integer multiple of the reference frequency may be found. In this manner, a very simple and inexpensive measurement of the characteristic curve of the VCO 16 is possible, so that the frequency fₒᵤₜ output by the frequency generator 30 may be varied very quickly by roughly presetting the control voltage of the VCO 16, as it has been described previously.

An example for a procedure in a determination of the characteristic curve of the VCO 16, without resorting to the value stored in the EEPROM 38, will be described in the following. The control means 42 opens the switch 32, adjusts the VCO 16 with a first experimental value S_{DAC} beforehand, closes the switch 32, and detects the value of S_{TP} after the required adjustment time. The first experimental value is for example a voltage value at which the control signal-oscillator frequency characteristic curve of the VCO is subject to the smallest changes due to the environmental variations and which will thus lead to a predetermined, known adjustment frequency with high probability despite environmental variations. In the example of FIG. 5, this would be a value near U₁. The control means 42 stores the value of S_{TP}+S_{DAC} in for example the EEPROM 38 or another suitable memory. After that, the control means 42 repeats this process for further experimental values increasing or decreasing by for example a constant value from experimental value to experimental value. The algorithm may of course cause the variation of the experimental value differently by changing the experimental value for example after an experimental process, in which the locked loop has adjusted to the next adjustment value, by a higher magnitude. Each time the value of S_{TP}+S_{DAC} rises or falls sharply or the detected value S_{TP} has a sharp change of sign from one experimental process to the next, the control means 42 stores the value S_{TP}+S_{DAC} as the next digital value for the next channel. In this manner the control means 42 obtains a complete sample of the characteristic curve of the VCO 16 at the ordinate locations N ω_{ref}. After the control means 42 has determined all digital values for all channels, it stores the same in the EEPROM 38.

In order to apply the experimental value to the input of the adder 34, the control means 42 may be connected to the second input of the adder 34 via the DAC 36 or another DAC directly or the control means 42 stores a digitized experimental value in a storage space specially provided for this in the EEPROM 38 and then accesses the same. In other words, in the channel association table of the EEPROM 38, a specially provided entry may be provided which does not correspond to any of the channels used by the transceiver circuit. In this case it would be possible for control means 42 to store the successively found-out or determined digital values directly into the EEPROM 38 for each channel.

It is pointed out that the switch 32 may also be switched into the feedback path at a point other than between the oscillator output and the sampler. Likewise, also the A/D converter 40 could be provided to have its input connected to the output of the adder 34. It would also be possible to bring forward the adder between sampler and filter. Furthermore, it would be possible to fetch the digitized rough presetting values previously described as stored values in another way than from a memory, such as analytical calculation of a parameter function adaptable to a changing characteristic curve of the VCO by the changing of parameters. The control means may be implemented in software or hardware or a combination thereof. Instead of a voltage-controlled oscillator, a current-controlled oscillator could also be used.

Moreover, it would be possible that the ADC 40 illustrated in FIG. 4 at the output of the low pass 14 is replaced by only a comparator in an alternative embodiment, which ascertains whether S_{LOC}(t)−S_{DAC}(t)=0. Finding the exact error of S_{LOC}(t) could then happen with a closed locked loop by variation of S_{DAC}(t). Depending on the sign of S_{LOC}(t)−S_{DAC}(t), S_{DAC}(t) would be decremented or incremented. In principle, S_{LOC}(t)−S_{DAC}(t) is digitized in this manner by the DAC 36, together with the comparator, forming an ADC functioning similarly to a sigma-delta modulator.

While this invention has been described in terms of several preferred embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A frequency generator, comprising:
a controllable oscillator comprising a control input and an oscillator output, wherein the controllable oscillator is formed to output, at the oscillator output, an oscillator signal with an oscillator frequency dependent on a control signal at the control input;
a sampler for sampling the oscillator signal or a signal of the controllable oscillator derived therefrom with a reference frequency in order to obtain a sample signal; and
a low-pass filter for low-pass filtering the sample signal or a signal derived therefrom in order to obtain the control signal or a signal underlying the control signal.

2. The frequency generator of claim 1, wherein the controllable oscillator, the sampler, and the low-pass filter are part of a locked loop controlling the oscillator signal to an oscillator frequency the ratio of which to the reference frequency is an integer.

3. The frequency generator of claim 2, further comprising:
a presetter for presetting the control signal, which is formed to
a) preset the control signal to a predetermined control value, and
b) then close the locked loop.

4. The frequency generator of claim 2, further comprising:
a determinator for determining the predetermined control value, which is formed to
a) preset the control signal to an experimental value,
b) then close the locked loop,
c) detect the value of the control signal adjusting itself upon closing the locked loop or of the control signal underlying the control signal, in order to obtain a value indicating the predetermined control value.

5. The frequency generator of claim 2, further comprising:
a memory for storing a plurality of predetermined control values each of which is associated with a different oscillator frequency to which the oscillator signal is adjusted by the locked loop.

6. The frequency generator of claim 2, further comprising:
an adjuster for adjusting the oscillator frequency, which is formed to
a) interrupt the locked loop,
b) preset the control signal to a predetermined control value,
c) then close the locked loop.

7. The frequency generator of claim 1, further comprising:
a manipulator for manipulating the signal underlying the control signal in order to obtain a predetermined additive constant control value in order to obtain the control signal for the controllable oscillator.

8. The frequency generator of claim 1, further comprising:
an adder switched between the low-pass filter and the controllable oscillator.

9. The frequency generator of claim 1, further comprising:
a switch for selectively preventing or enabling the oscillator signal to reach the control input, passing through the sampler and the low-pass filter.

10. The frequency generator of claim 9, wherein the switch for selectively preventing or enabling is a switch between the sampler and the oscillator output of the controllable oscillator.

11. The frequency generator of claim 9, further comprising:
an adder formed to add a predetermined constant control value to the signal underlying the control signal in order to obtain the control signal;
a controller for adjusting the oscillator frequency, which is formed to cause
a) the switch for selectively preventing or enabling to prevent the oscillator signal from reaching the control input, passing through the sampler and the low-pass filter;
b) the adder to then use a different predetermined constant control value for addition; and
c) the switch for selectively preventing or enabling to then enable the oscillator signal to reach the control input, passing through the sampler and the low-pass filter.

12. The frequency generator of claim 11, further comprising:
a memory in which digital values are stored and which is formed to output a selected digital value in response to a selection among the digital values;
a digital/analog converter for converting the output digital value to an analog control value and outputting the same to the adder as the predetermined constant control value,
wherein the controller is formed to access the memory when adjusting the oscillator frequency, in order to make a selection among the digital values corresponding to the different predetermined constant control value, in order to cause the adder to use a different constant control value for addition.

13. The frequency generator of claim 11, further comprising:
a detector for detecting the value of the control signal; and
a controller for determining the predetermined constant control value, which is formed to cause
a) the switch for selectively preventing or enabling to prevent the oscillator signal from reaching the control input, passing through the sampler and the low-pass filter;
b) the adder to then use an experimental value for addition;
c) the switch for selectively preventing or enabling to then enable the oscillator signal to reach the control input, passing through the sampler and the low-pass filter;
d) the detector to then detect the value of the control signal resulting upon enabling, in order to obtain the predetermined constant control value.

14. The frequency generator of claim 12, further comprising:
an A/D converter for detecting the value of the control signal in order to obtain a digital detection value; and
a controller for again determining a digital value in the memory, which is formed to cause
a) the switch for selectively preventing or enabling to prevent the oscillator signal from reaching the control input, passing through the sampler and the low-pass filter;
b) the memory to output the current digital value in order to cause the adder to use the corresponding analog control value as the predetermined constant control value;
c) the switch for selectively preventing and enabling to then enable the oscillator signal to reach the control input, passing through the sampler and the low-pass filter;
d) the detector to then detect the value of the control signal resulting upon enabling, in order to obtain a value indicating the predetermined constant control value as a new digital value; and
e) the current digital value to be replaced by the new digital value in the memory.

15. A method of frequency generation by means of a controllable oscillator comprising a control input and an oscillator output, wherein the controllable oscillator is formed to output, at the oscillator output, an oscillator signal with an oscillator frequency dependent on a control signal at the control input, the method comprising the steps of:
sampling the oscillator signal or a signal of the controllable oscillator derived therefrom with a reference frequency in order to obtain a sample signal; and
low-pass filtering the sample signal or a signal derived therefrom, in order to obtain the control signal or a signal underlying the control signal.

16. An apparatus for determining the control signal-oscillator frequency characteristic curve of a controllable oscillator comprising a control input and an oscillator output, wherein the controllable oscillator is formed to output, at the oscillator output, an oscillator signal with an oscillator frequency dependent on a control signal from the control input, the apparatus comprising:
a sampler for sampling the oscillator signal or a signal of the controllable oscillator derived therefrom with a reference frequency in order to obtain a sample signal;
a low-pass filter for low-pass filtering the sample signal or a signal derived therefrom, in order to obtain a signal underlying the same;
a switch for selectively preventing or enabling the oscillator signal to reach the control input, passing through the sampler and the low-pass filter;
an adder formed to add a predetermined constant control value to the signal underlying the control signal, in order to obtain the control signal;
a detector for detecting the value of the control signal; and
a controller for determining the predetermined constant control value, which is formed to cause
the switch for selectively preventing or enabling to prevent the oscillator signal from reaching the control input, passing through the sampler and the low-pass filter;
the adder to then use an experimental value for addition;
the switch for preventing or enabling to then enable the oscillator signal to reach the control input, passing through the sampler and the low-pass filter;
the detector to then detect the value of the control signal adjusting itself upon enabling, in order to obtain a control value associated with a predetermined multiple of the reference frequency via the control signal-oscillator frequency characteristic curve; and
these processes to be repeated for various experimental values.

17. A method of determining the control signal-oscillator frequency characteristic curve of a controllable oscillator comprising a control input and an oscillator output, wherein the controllable oscillator is formed to output, at the oscillator output, an oscillator signal with an oscillator frequency dependent on a control signal from the control input, the method comprising the steps of:
sampling the oscillator signal of the controllable oscillator or a signal derived therefrom with a reference frequency, in order to obtain a sample signal;
low-pass filtering the sample signal or a signal derived therefrom, in order to obtain a signal underlying the same;
preventing the oscillator signal from reaching the control input, passing through the sampler and the low-pass filter;
adding an experimental value to the signal underlying the control signal, in order to obtain the control signal;
enabling the oscillator signal to reach the control input, passing through the sampler and the low-pass filter;
detecting the value of the control signal adjusting itself upon enabling, in order to obtain a control value associated with an integer multiple of the reference frequency via the control signal-oscillator frequency characteristic curve; and
repeating the steps for various experimental values.
